(19) United States
(12) Patent Application Publication
(10) Pub. No.: US 2025/0342018 A1
(43) Pub. Date: Nov. 6, 2025

(54) AUTOMATED GENERATION OF CONDITIONAL INPUTS

(71) Applicant: Truist Bank, Charlotte, NC (US)

(72) Inventor: Saloni Uboweja, Cary, NC (US)

(73) Assignee: Truist Bank, Charlotte, NC (US)

(21) Appl. No.: 18/651,773

(22) Filed: May 1, 2024

(51) Int. Cl. G06F 8/38; G06F 9/451

(52) U.S. Cl. CPC G06F 8/38; G06F 9/451

(57) ABSTRACT

Disclosed are systems and methods for building a customized conditional input interface that captures system configuration data and network activity data from a remote user computing device. The system determines an engagement driver identification using the system configuration data and the network activity data as well as end user data loaded from an end user database. The system generates a text data output as notification content data based on the engagement driver identification and the end user data. The system then packages the notification content data with interface assembly instruction software code that, when executed by a user computing device, outputs the notification content data to a display device integrated with the end user computing device.

### TECHNICAL FIELD AND BACKGROUND

The present invention relates to systems and methods for capturing user attributes, activity, and device data that is processed using machine learning technology to generate customized user interfaces that output notifications requiring end user input as a condition for proceeding with system use.

End users can be presented with a conditional input and notification content data where the conditional input must be selected before the end user continues with system use. Conventional methods for generating required notification content data rely on standardized notification content that is agnostic to end user attributes and activity. Without expedient access to a notification content for simultaneous or delayed review and processing by end users, notification content data must be presented verbally to end users. The result is that engagements with end users can be costly, time consuming, and inefficient.

To address the drawbacks of conventional systems, disclosed herein are systems and methods that capture a variety of user and device attribute and function data that is used to generate notification data that is displayed to a particular user for review and acknowledgment. The generation of the notification thereby eliminates the use of the vocal expression to present a notification to achieve increased agent efficiency. The review, consent and/or acknowledgment can be tracked by the enterprise as needed.

### SUMMARY

According to one embodiment, a system for building a customized conditional interface includes a computing device that has a processor, a memory device storing data, and executable code. When executed, the code causes the processor to: (a) capture system configuration data and network activity data from a remote user computing device; (b) determine an engagement driver identification using the system configuration data and the network activity data as well as end user data loaded from an end user database; (c) generate notification content data based on the engagement driver identification and the end user data; and (d) package the notification content data with interface assembly instruction software code. The interface assembly instruction software code outputs notification content data to a display device integrated with the end user computing device when the code is executed.

The first computing device comprises at least one neural network and the neural network is used to determine the engagement driver identification. The neural network can be implemented as a support vector machine network architecture or a ConvNet architecture.

Running executable code stored to a second memory device causes a second processor to: (a) capture notification content data transmitted to the user computing device; (b) create a notification database record comprising the network activity data, the system configuration data, end user account data, and the notification content data; (c) generate known labeling data using the notification database record; (d) generate an error rate by comparing the notification content data to the known labeling data; and (e) training the at least one neural network by adjusting one or more neural network parameters to reduce the error rate.

Executing the interface assembly instruction software code by the user computing device causes the device to display the notification content data on a graphical user interface that is output to the display device. The computing device comprises at least one neural network and the neural network is used to generate the notification content data. The neural network can be configured with a support vector machine network architecture or a ConvNet architecture.

The user computing device processes the notification content data and the interface assembly instructions to generate the graphical user interface, The graphical user interface comprises a accept function, that when selected by an end user, the first computing device transmits an alert to an agent computing device permitting an engagement between the end user and an agent to proceed.

### BRIEF DESCRIPTION OF THE DRAWINGS

Features, aspects, and advantages of the present invention are better understood when the following detailed description of the invention is read with reference to the accompanying figures described below.

FIG. 1 is an example system diagram according to one embodiment.

FIG. 2A is a diagram of a feedforward network, according to at least one embodiment, utilized in machine learning.

FIG. 2B is a diagram of a ConvNet, according to at least one embodiment, utilized in machine learning.

FIG. 2C is a diagram of a portion of the ConvNet of FIG. 2B, according to at least one embodiment, illustrating assigned weights at connections or neurons.

FIG. 3 is a diagram representing an example weighted sum computation in a node in an artificial neural network.

FIG. 4 is a diagram of a RNN, according to at least one embodiment, utilized in machine learning.

FIG. 5 is a schematic logic diagram of an artificial intelligence program including a front-end and a back-end algorithm.

FIG. 6 is a flow chart representing a method, according to at least one embodiment, of model development and deployment by machine learning.

FIG. 7 is an example graphical user interface according to at least one embodiment.

### DETAILED DESCRIPTION

The present invention will now be described more fully hereinafter with reference to the accompanying drawings in which example embodiments of the invention are shown. However, the invention may be embodied in many different forms and should not be construed as limited to the representative embodiments set forth herein. The exemplary embodiments are provided so that this disclosure will be both thorough and complete and will fully convey the scope of the invention and enable one of ordinary skill in the art to make, use, and practice the invention. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

It will be understood that relative terms are intended to encompass different orientations or sequences in addition to the orientations and sequences depicted in the drawings and described herein. Relative terminology, such as “substantially” or “about,” describe the specified devices, materials, transmissions, steps, parameters, or ranges as well as those that do not materially affect the basic and novel characteristics of the claimed inventions as whole (as would be appreciated by one of ordinary skill in the art).

The terms “coupled,” “fixed,” “attached to,” “communicatively coupled to,” “operatively coupled to,” and the like refer to both: (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

As used herein, the terms “agent” generally describe an individual providing account services on behalf of an enterprise. The term “account” generally denotes an ongoing arrangement between an end user and a provider agent where an enterprise provides goods or services on a long-term basis. The term “user” generally describes an individual or entity that utilizes an account or purchases products and services from an agent representative. The term user may be used interchangeably with the terms end user, customer, consumer, or client.

Embodiments are described with reference to flowchart illustrations or block diagrams of methods or apparatuses where each block or combinations of blocks can be implemented by computer-readable instructions (i.e., software). The term apparatus includes systems and computer program products. The referenced computer-readable software instructions may be provided to a processor of a general purpose computer, special purpose computer, or other programmable data processing apparatus to produce a particular machine. The instructions, which execute via the processor of the computer or other programmable data processing apparatus, create mechanisms for implementing the functions specified in this specification and attached figures.

The computer-readable instructions are loaded onto a computer or other programmable data processing apparatus to cause a series of operational steps to be performed on the computer or other programmable apparatus to produce a computer-implemented process such that the instructions, which execute on the computer or other programmable apparatus, provide steps for implementing the functions specified in the attached flowchart(s) or block diagram(s). Alternatively, computer software implemented steps or acts may be combined with operator or human implemented steps or acts in order to carry out an embodiment of the disclosed systems and methods.

The computer-readable software instructions may also be stored in a computer-readable memory that can direct a computer or other programmable data processing apparatus to function in a particular manner. In this manner, the instructions stored in the computer-readable memory produce an article of manufacture that includes the instructions, which implement the functions described and illustrated herein.

### System Level Description

Disclosed are systems and methods for presenting a notification that is customized and displayed to a particular user based on user attributes, functions, and device data, for review, consent and/or acknowledgment, of which the later action can be tracked by the enterprise. The systems and methods are described with reference to example embodiments for engagements implemented by a service agent that generate notifications for simultaneous or delayed review and consent by end users that seek help in initializing, maintaining, or upgrading an account with the enterprise. Those of skill in the art will appreciate, however, that the example embodiments are not intended to be limiting, and the described systems and methods could also be applied to implement and optimize electronic engagements in other industries or contexts.

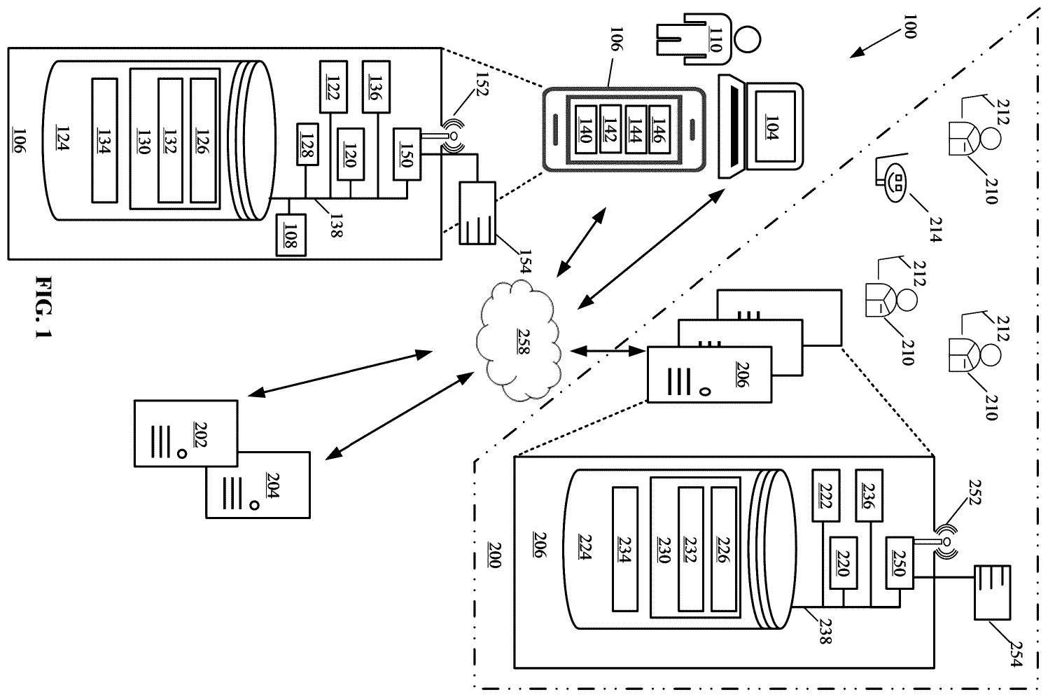

As shown in FIG. 1, a hardware system 100 configuration according to one embodiment generally includes a user 110 that benefits through use of services and products offered by a provider through an enterprise system 200. The user 110 accesses services and products by use of one or more user computing devices 104 & 106. The user computing device can be a larger device, such as a laptop or desktop computer 104, or a mobile computing device 106, such as smart phone or tablet device with processing and communication capabilities. The user computing device 104 & 106 includes integrated software applications that manage device resources, generate user interfaces, accept user inputs, and facilitate communications with other devices, among other functions. The integrated software applications can include an operating system, such as Linux®, UNIX®, Windows®, macOS®, iOS®, Android®, or other operating system compatible with personal computing devices.

The user 110 can be an individual, a group, or an entity having access to the user computing device 104 & 106. Although the user 110 is singly represented in some figures, at least in some embodiments, the user 110 is one of many, such as a market or community of users, consumers, customers, business entities, government entities, and groups of any size.

The user computing device includes subsystems and components, such as a processor 120, a memory device 122, a storage device 124, or power system 128. The memory device 122 can be transitory random access memory (“RAM”) or read-only memory (“ROM”). The storage device 124 includes at least one of a non-transitory storage medium for long-term, intermediate-term, and short-term storage of computer-readable instructions 126 for execution by the processor 120. For example, the instructions 126 can include instructions for an operating system and various integrated applications or programs 130 & 132. The storage device 124 can store various other data items 134, including, without limitation, cached data, user files, pictures, audio and/or video recordings, files downloaded or received from other devices, and other data items preferred by the user, or related to any or all of the applications or programs.

The memory device 122 and storage device 124 are operatively coupled to the processor 120 and are configures to store a plurality of integrated software applications that comprise computer-executable instructions and code executed by the processing device 120 to implement the functions of the user computing device 104 & 106 described herein. Example applications include a conventional Internet browser software application and a mobile software application created by the provider to facilitate interaction with the enterprise system 200.

According to various embodiments, the memory device 122 and storage device 124 may be combined into a single storage medium. The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (“GUI”) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The integrated software applications also typically provide a GUI on the user computing device display screen 140 that allows the user 110 to utilize and interact with the user computing device. Example GUI display screens are depicted in the attached figures. The GUI display screens may include features for displaying information and accepting inputs from users, such as text boxes, data fields, hyperlinks, pull down menus, check boxes, radio buttons, and the like. One of ordinary skill in the art will appreciate that the example functions and user-interface display screens shown in the attached figures are not intended to be limiting, and an integrated software application may include other display screens and functions.

The processing device 120 performs calculations, processes instructions for execution, and manipulates information. The processing device 120 executes machine-readable instructions stored in the storage device 124 and/or memory device 122 to perform methods and functions as described or implied herein. The processing device 120 can be implemented as a central processing unit (“CPU”), a microprocessor, a graphics processing unit (“GPU”), a microcontroller, an application-specific integrated circuit (“ASIC”), a programmable logic device (“PLD”), a digital signal processor (“DSP”), a field programmable gate array (“FPGA”), a state machine, a controller, gated or transistor logic, discrete physical hardware components, and combinations thereof. In some embodiments, particular portions or steps of methods and functions described herein are performed in whole or in part by way of the processing device 120. In other embodiments, the methods and functions described herein include cloud-based computing such that the processing device 120 facilitates local operations, such communication functions, data transfer, and user inputs and outputs.

The mobile device 106, as illustrated, includes an input and output system 136, referring to, including, or operatively coupled with, one or more user input devices and/or one or more user output devices, which are operatively coupled to the processing device 120. The input and output system 136 may include input/output circuitry that may operatively convert analog signals and other signals into digital data, or may convert digital data to another type of signal. For example, the input/output circuitry may receive and convert physical contact inputs, physical movements, or auditory signals (e.g., which may be used to authenticate a user) to digital data. Once converted, the digital data may be provided to the processing device 120. The input and output system 136 may also include a display 140 (e.g., a liquid crystal display (LCD), light emitting diode (LED) display, or the like), which can be, as a non-limiting example, a presence-sensitive input screen (e.g., touch screen or the like) of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, infrared sensor, and/or other input device(s). The input and output system 136 may also include a camera 146, such as a digital camera.

Further non-limiting examples of input devices and/or output devices include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The user computing device 104 & 106 may also include a positioning device 108, such as a global positioning system device (“GPS”) that determines a location of the user computing device. In other embodiments, the positioning device 108 includes a proximity sensor or transmitter, such as an RFID tag, that can sense or be sensed by devices proximal to the user computing device 104 &106.

The input and output system 136 may also be configured to obtain and process various forms of authentication via an authentication system to obtain authentication information of a user 110. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

A system intraconnect 138, such as a bus system, connects various components of the mobile device 106. The user computing device 104 & 106 further includes a communication interface 150. The communication interface 150 facilitates transactions with other devices and systems to provide two-way communications and data exchanges through a wireless communication device 152 or wired connection 154. Communications may be conducted via various modes or protocols, such as through a cellular network, wireless communication protocols using IEEE 802.11 standards. Communications can also include short-range protocols, such as Bluetooth or Near-field communication protocols. Communications may also or alternatively be conducted via the connector 154 for wired connections such by USB, Ethernet, and other physically connected modes of data transfer.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210 act on behalf of the provider, such as customer service representatives, advisors, managers, and sales team members.

Human agents 210 utilize agent computing devices 212 to interface with the enterprise system 200. The agent computing devices 212 can be, as non-limiting examples, computing devices, kiosks, terminals, smart devices such as phones, and devices and tools at customer service counters and windows at POS locations. In at least one example, the diagrammatic representation and above-description of the components of the user computing device 104 & 106 in FIG. 1 applies as well to the agent computing devices 212. As used herein, the general term “end user computing device” can be used to refer to either the agent computing device 212 or the user 110 depending on whether the agent (as an employee or affiliate of the provider) or the user (as a customer or consumer) is utilizing the disclosed systems and methods to segment, parse, filter, analyze, and display content data.

Human agents 210 interact with users 110 or other agents 210 by phone, via an instant messaging software application, or by email. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components, such as a processor device 220, an input-output system 236, an intraconnect bus system 238, a communication interface 250, a wireless device 252, a hardwire connection device 254, a transitory memory device 222, and a non-transitory storage device 224 for long-term, intermediate-term, and short-term storage of computer-readable instructions 226 for execution by the processor device 220. The instructions 226 can include instructions for an operating system and various software applications or programs 230 & 232. The storage device 224 can store various other data 234, such as cached data, files for user accounts, user profiles, account balances, and transaction histories, files downloaded or received from other devices, and other data items required or related to the applications or programs 230 & 232.

The enterprise system 200 can include components such as a web server that interfaces with remote computing devices to exchange data and information over the Internet, a firewall, and one or more back end computing devices that store end user data and that are secured behind a firewall. The enterprise computing system can also include an identity management service that stores information concerning the identities and authentication credentials of agents, representatives, and end users.

The network 258 provides wireless or wired communications among the components of the hardware system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations.

The network 258 may be or include an enterprise or secured network, or may be implemented, at least in part, through one or more connections to the Internet. A portion of the network 258 may be a virtual private network (“VPN”) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated hardware system 100.

External systems 202 and 204 represent any number and variety of data sources, users, consumers, customers, enterprises, and groups of any size. In at least one example, the external systems 202 and 204 represent remote terminal utilized by the enterprise system 200 in serving users 110. In another example, the external systems 202 and 204 represent electronic systems for processing payment transactions. The system may also utilize software applications that function using external resources 202 and 204 available through a third-party provider, such as a Software as a Service (“SaaS”), Platform as a Service (“PaaS”), or Infrastructure as a Service (“IaaS”) provider running on a third-party cloud service computing device. For instance, a cloud computing device may function as a resource provider by providing remote data storage capabilities or running software applications utilized by remote devices.

SaaS may provide a user with the capability to use applications running on a cloud infrastructure, where the applications are accessible via a thin client interface such as a web browser and the user is not permitted to manage or control the underlying cloud infrastructure (i.e., network, servers, operating systems, storage, or specific application capabilities that are not user-specific). PaaS also do not permit the user to manage or control the underlying cloud infrastructure, but this service may enable a user to deploy user-created or acquired applications onto the cloud infrastructure using programming languages and tools provided by the provider of the application. In contrast, IaaS provides a user the permission to provision processing, storage, networks, and other computing resources as well as run arbitrary software (e.g., operating systems and applications) thereby giving the user control over operating systems, storage, deployed applications, and potentially select networking components (e.g., host firewalls).

The network 258 may also incorporate various cloud-based deployment models including private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public).

The embodiment shown in FIG. 1 is not intended to be limiting, and one of ordinary skill in the art will appreciate that the system and methods of the present invention may be implemented using other suitable hardware or software configurations. For example, the system may utilize only a single computing system 206 implemented by one or more physical or virtual computing devices, or a single computing device may implement one or more of the computing system 206, agent computing device 212, or user computing device 104 & 106.

### Capturing User Evaluation Data

Engagements between a provider and an end user often require presenting notification content data to end users. The notification content data is associated with a notification identification that is generated by a provider network device or an agent computing device. A notification identification specifies a particular notification, notice, or material that is to be provided as part of an electronic engagement. The notification identification can be a name, serial number, or other identifier for a particular notification. Non-limiting examples of notifications include providing end users with a notification related to a checking account, a home loan, or personal loan. In each case, the product is associated with a notification identification and notification content data.

The notification content data includes a variety information used to generate the notice and that may be output to an end user computing device. Notification content data can include alphanumerical text data that describes a particular transaction, end user, end user computing device, or end user attributes. Notification content data can include notification parameter data such as dates and times, a transaction type, a notification type, resource availability data, thresholds, and value data. For instance, the notification parameter data could include a discrete set of monetary amounts (e.g., $100, $200, $500), discrete ranges of interest rates for a loan (e.g., 4-5%), or length of loan (e.g., 10 years). In that case, the notification type data identifies the type of notification provided to the user (e.g., monetary sum, interest rate, months with no payment owed), and the notification data indicates the numeric value of the offer (e.g., $500 sum, 3% interest, 2 months, etc.).

The notification identification and notification parameter data can be varied depending on user evaluation data, as explained in detail below. The notification parameter data can be established by an enterprise as part of electronic engagement design, such as parameters that direct a notification to be presented to certain users but not others.

User evaluation data includes a wide variety of information that is used by the enterprise system to evaluate what notification a user may require. User evaluation data includes, without limitation: (i) navigation data; (ii) system configuration data and (iii) end user account data. User evaluation data is captured when a user computing device is used to access the enterprise system to solicit data to be displayed on the user computing device. User computing devices access the enterprise system through an Internet browser software application or a dedicated enterprise mobile software application that displays one or more GUI screens.

Agent-user interactions generally commence when a user contacts a provider through an incoming interaction request. The incoming interaction request includes incoming interaction initialization data, which can be multi-frequency signal tones or data packets representing a user device IP address, email address, or digital routing information. The enterprise system includes a source identification software service that processes the incoming interaction initialization data to generate user source data, such as a telephone number, a user device Internet Protocol (“IP”) Address, an email address, or a social media or other account name.

The source identification software service determines the telephone number of the incoming call source as incoming telephone number data using techniques that can include, for example, automatic number identification (“ANI”). In that case, the incoming interaction initialization data can be ANI data, which is generally transmitted along with an incoming telephone call using multi-frequency signaling, which can be a digital tone that is translated to a numeric value. For Voice-over-Internet Protocol (“VoIP”) calling, the incoming telephone number can instead be received as packets of digital information within the incoming interaction initialization data. The source identification software service processes the incoming interaction initialization data (i.e., the ANI data or IP data packets) to determine the source data as incoming telephone number data. The enterprise system uses the incoming telephone number data to query an internal database to determine whether the incoming telephone number corresponds to an existing end user.

When an end user initiates a provider-end user interaction by communicating with an enterprise through written electronic communications or VoIP, the communications originate from a user computing device, such as a personal computer, a smart phone, or tablet computing device. In that instance, the source identification software service processes the incoming initialization data to capture or determine user source data that can include a user device IP address for the user computing device, an email address, or a social media or other account name.

The enterprise system utilizes the user source data to transmit a query to the enterprise's internal End User Database to determine if an existing database record matches user source data. In this manner, either the incoming telephone number, the user device IP address, email address, or other user source data is used to determine to identity of the user and whether the user is a current or former enterprise customer.

The End User Database comprises user database records that correspond to individual customers, or users. The user database records store a variety of user account data, including, without limitation: (i) a user identification; (ii) user contact data, including a mailing address or a geographic region where the user resides (e.g., a zip code, city, state); (iii) user source data, such as user telephone number data, user device IP Address data, an email address, or a social media account name; (iv) user demographic data, including the gender and age of a user; (v) one or more product identifications that indicate the accounts or products currently held by a user (e.g., a checking account, a home loan, brokerage account, etc.); (vi) user resource availability data (e.g., balances for various product types or account types associated with, or held by, a user); (vii) average resource availability data that indicates the average value of products or account balances maintained by the user over a given time period (e.g., an average monthly balance for an account held by the user); (viii) transaction data that includes data and information relating to user transactions, such as payment amounts, dates when a transaction occurred, data that identifies other parties to the transaction (i.e., a payment recipient), and information identifying a category of expenditures for the transaction (i.e., groceries, transportation, etc.); (ix) average resource utilization volume data indicating the average number of transactions a user conducts using a given product over a given time period (e.g., the number of resource expenditures per month for a given account or accounts); (x) user online activity data indicating user attempts to log into the enterprise system to access user accounts or other activities performed by users online or through a dedicated mobile device software application; or (xi) system configuration data, as described below.

The enterprise system can further determine geographic location data based on the incoming telephone number data or user device IP address. The enterprise system can include a software application that transmits the incoming telephone number data or the user device IP address to an Identity & Location API that utilizes the phone number or IP Address to determine the approximate geographic location of the user computing device. The Identity & Location API can pass the incoming telephone number or user device IP address to a database or a third-party software service that returns geographic location data corresponding to an approximate geographic location for the telephone number or the user device IP address, such as a city, county, or state. The Identity & Location API stores the geographic data to a database record with the content data.

In accessing the enterprise system through a user computing device, the user computing device transmits a user interface transmit command to an enterprise network device, which can be a web server. The interface transmit command can include: (i) an IP address for the user computing device; (ii) navigation data; and (iii) system configuration data. In response to the user interface transmit command, the enterprise system returns display data and a digital cookie that is stored to the user computing device and used to track functions and activities performed by the user computing device.

In some embodiments, the navigation data and system configuration data are utilized by the enterprise system to generate the representative display data. For instance, the system configuration data may indicate that the user computing device is utilizing a particular Internet browser or mobile software application to communicate with the enterprise system. The enterprise system then generates representative display data that includes instructions compatible with, and readable by, the particular Internet browser or mobile software application. As another example, if the navigation data indicate the user computing device previously visited a representative mobile software application, the representative display data can include instructions for displaying a customized message on the user computing device, such as “Welcome back Patrick!”

After receiving representative display data, the user computing device processes the display data and renders GUI screens presented to users, such as a GUI within a representative mobile software application. The enterprise system also transmits the navigation data and system configuration data to the agent for processing as user evaluation data. Note that in some embodiments, the navigation data and system configuration data may be sent to the enterprise system in a separate message subsequent to the user interface transmit command message.

The representative display data can include one or more of the following: (i) mobile app display data used by the user computing device to render GUI screens within a mobile software application; and (ii) notification display data that is used by the user computing device to render a banner that provides users access to view, select, and accept a notification provided as part of an electronic engagement. Categories of mobile app display data can include graphical elements, digital images, text, numbers, colors, fonts, or layout data representing the orientation and arrangement graphical elements and alphanumeric data on a user interface screen.

Navigation data can also called “network activity data” as it reflects end user computing device activity in accessing the Internet or a local network. The navigation data is transmitted by the user computing device generally includes information relating to prior functions and activities performed by the user computing device. Examples of navigation data include: (i) navigation history data (i.e., identifiers like IP addresses showing places previously access by the user computing device); (ii) redirect data (i.e., data indicating whether the user computing device selected a third-party universal resource locator (“URL”) link that redirected to the enterprise system such as a web server); and (iii) search history data (e.g., data showing keyword searches in a search engine, like Google® or Bing®, performed by the user computing device).

Navigation history data allows an agent to determine whether a user computing device was previously used to visit particular Internet locations. The navigation history data includes, without limitation: (i) URL data identifying a hyperlink link to Internet location; (ii) web location identification data, such as a title of an Internet location; (iii) IP address data indicating an IP address for a web server associated with a visited Internet location; and (iv) time stamp data indicating the date and time when an Internet location was accessed.

Search history data is generated when a user computing device runs a query within a search engine. The search history data can include, without limitation: (i) a search engine identifier indicating the search engine that was utilized; (ii) search parameter data indicating the alphanumeric strings or operators used as part of a search query (e.g., Boolean operators such as “AND” or “OR” or functional operators); and (iii) time stamp data indicating the date and time a search was performed.

The user computing device may also transmit system configuration data to the enterprise system that is used to evaluate a user or authenticate the user computing device. System configuration data can include, without limitation: (i) a unique identifier for the user computing device (e.g., a media access control (“MAC”) address hardcoded into a communication subsystem of the user agent computing device); (ii) a MAC address for the local network of a user computing device (e.g., a router MAC address); (iii) copies of key system files that are unlikely to change between instances when a user accesses the enterprise system; (iv) a list of applications running or installed on the user computing device; and (v) any other data useful for evaluating users and authenticating a user or user computing device.

The user computing device optionally authenticates to the enterprise system if, for instance, the user has an existing electronic account with the enterprise. The user computing device navigates to a login interface and enters user security data, such as a user name and password. The user then selects a submit function on an user interface display screen to transmit an user security collection message that includes the user authentication data to the provider system. In some embodiments, the user security data and user authentication collection message can further include elements of the system configuration data that are used to authenticate the user, such as a user computing device identifier or internet protocol address.

The enterprise system passes user authentication collection message to the enterprise system, which performs a verification analysis to verify the identity of the user or the user computing device. The verification analysis can compare the received user security data to stored user security data to determine whether the security data sets match. In this manner, the enterprise system determines whether a correct user name, password, device identifier, or other authentication data is received. The enterprise system returns an authentication notification message to the enterprise system. The authentication notification message includes a verification flag indicating whether the verification passed or failed and a reason for any failed authentication, such as an unrecognized user name, password, or user computing device identifier.

The user authentication collection message can also include system configuration data, and the enterprise system can use system configuration data and user account data to perform the authentication process. As one example, the enterprise system might store a user computing device MAC address to a database record as part of the user account data. Upon receipt of an user authentication collection message that includes a MAC address, the enterprise system compares the received MAC address against stored MAC address data associated with the user account data. In this manner, the user computing device can also be authenticated to the enterprise system. If the received and stored MAC addresses do not match, the enterprise system returns an authentication decision message to the enterprise system indicating the authentication failed because the user computing device could not be authenticated. The enterprise system can then prompt the user to verifying whether the consumer is using a new device to login to the enterprise system, and if so, being the process of registering a new device to the enterprise's system.

The system may also utilize multifactor authentication techniques (“MFA”) to authenticate the user identity or a user computing device. As one example, if the user authentication data is successfully verified, a MFA software process running on the enterprise system can initiate a telephone call to a phone number stored as part of the use account data. Upon receiving the call, the user selects an input function on the telephone to transmit response data to the MFA software process that confirms receipt of the call, thereby further authenticating the user's identity. The function can be the user's selection of any key on the telephone or a pre-determined sequence of keys, such as a passcode. Those of skill in the art will appreciate that other forms of MFA are possible, such as sending a text message containing a passcode to the user's cellular phone that must be entered into a user interface screen.

Following successful user authentication, the enterprise system transmits a verification notification message to the agent that includes an unique user identifier (e.g., a user name or customer number) and a verification flag that indicates whether the user was successfully authenticated and/or logged into the enterprise system. The agent can respond by sending an user data collection message to the back end server. The back end server responds to the user data collection message by transmitting a user account data packet to the engagement manner that includes user account data for storage and processing as user evaluation data.

### Artificial Intelligence Systems

A machine learning program may be configured to implement stored processing, such as decision tree learning, association rule learning, artificial neural networks, recurrent artificial neural networks, long short term memory networks, inductive logic programming, support vector machines, clustering, Bayesian networks, reinforcement learning, representation learning, similarity and metric learning, sparse dictionary learning, genetic algorithms, k-nearest neighbor (“KNN”), and the like. Additionally or alternatively, the machine learning algorithm may include one or more regression algorithms configured to output a numerical value in response to a given input. Further, the machine learning may include one or more pattern recognition algorithms—e.g., a module, subroutine or the like capable of translating text or string characters and/or a speech recognition module or subroutine. The machine learning modules may include a machine learning acceleration logic (e.g., a fixed function matrix multiplication logic) that implements the stored processes or optimizes the machine learning logic training and interface.

The machine learning modules utilized by the present systems and methods can be implemented with neural network techniques. Neural networks learn to perform tasks by processing examples, without being programmed with any task-specific rules. A neural network generally includes connected units, neurons, or nodes (e.g., connected by synapses) and may allow for the machine learning program to improve performance. A neural network may define a network of functions, which have a graphical relationship. As an example, a feedforward network may be utilized, such as an acyclic graph with nodes arranged in layers.

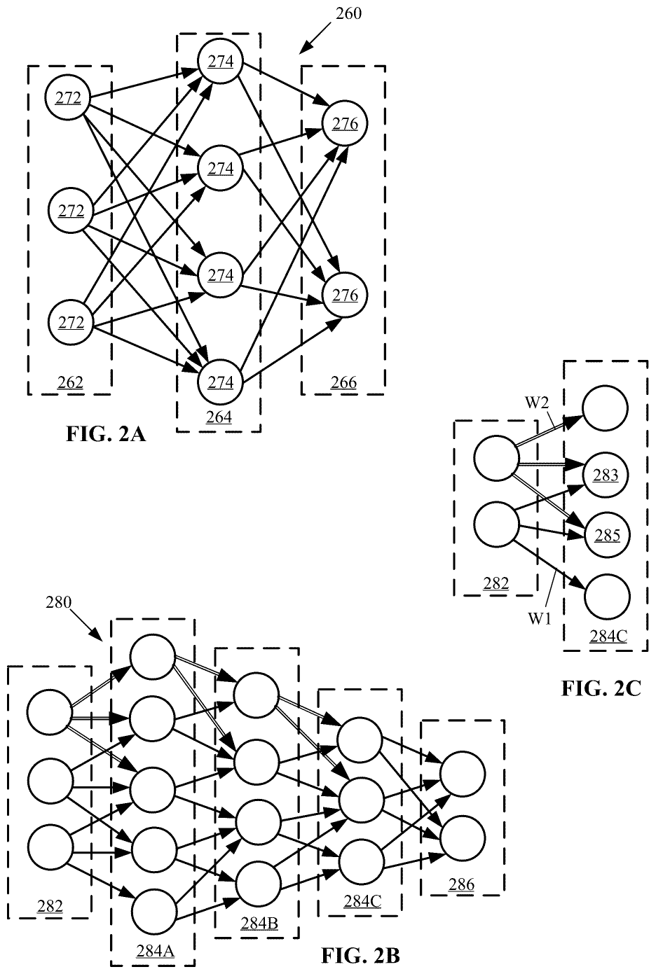

A feedforward network 260 (as depicted in FIG. 2A) may include a topography with a hidden layer 264 between an input layer 262 and an output layer 266. The input layer 262 includes input nodes 272 that communicate input data, variables, matrices, or the like to the hidden layer 264 that is implemented with hidden layer nodes 274. The hidden layer 264 generates a representation and/or transformation of the input data into a form that is suitable for presenting output data. Adjacent layers of the topography are connected at the edges of the nodes of the respective layers, but nodes within a layer typically are not separated by an edge.

In at least one embodiment of such a feedforward network, data is communicated to the input nodes 272 of the input layer, which then communicates the data to the hidden layer 264. The hidden layer 264 may be configured to determine the state of the nodes in the respective layers and assign weight coefficients or parameters of the nodes based on the edges separating each of the layers. That is, the hidden layer 264 implements activation functions between the input data communicated from the input layer 262 and the output data communicated to the output nodes 276 of the output layer 266.

It should be appreciated that the form of the output from the neural network may generally depend on the type of model represented by the algorithm. Although the feedforward network 260 of FIG. 2A expressly includes a single hidden layer 264, other embodiments of feedforward networks within the scope of the descriptions can include any number of hidden layers. The hidden layers are intermediate the input and output layers and are generally where all or most of the computation is done.

Neural networks may perform a supervised learning process where known inputs and known outputs are utilized to categorize, classify, or predict a quality of a future input. However, additional or alternative embodiments of the machine learning program may be trained utilizing unsupervised or semi-supervised training, where none of the outputs or some of the outputs are unknown, respectively. Typically, a machine learning algorithm is trained (e.g., utilizing a training data set) prior to modeling the problem with which the algorithm is associated. Supervised training of the neural network may include choosing a network topology suitable for the problem being modeled by the network and providing a set of training data representative of the problem.

Generally, the machine learning algorithm may adjust the weight coefficients until any error in the output data generated by the algorithm is less than a predetermined, acceptable level. For instance, the training process may include comparing the generated output produced by the network in response to the training data with a desired or correct output. An associated error amount may then be determined for the generated output data, such as for each output data point generated in the output layer. The associated error amount may be communicated back through the system as an error signal, where the weight coefficients assigned in the hidden layer are adjusted based on the error signal. For instance, the associated error amount (e.g., a value between −1 and 1) may be used to modify the previous coefficient (e.g., a propagated value). The machine learning algorithm may be considered sufficiently trained when the associated error amount for the output data is less than the predetermined, acceptable level (e.g., each data point within the output layer includes an error amount less than the predetermined, acceptable level). Thus, the parameters determined from the training process can be utilized with new input data to categorize, classify, and/or predict other values based on the new input data.

An additional or alternative type of neural network suitable for use in the machine learning program and/or module is a Convolutional neural network (“ConvNet”). A ConvNet is a type of feedforward neural network that may be utilized to model data associated with input data having a grid-like topology. In some embodiments, at least one layer of a ConvNet may include a sparsely connected layer, in which each output of a first hidden layer does not interact with each input of the next hidden layer. For example, the output of the convolution in the first hidden layer may be an input of the next hidden layer, rather than a respective state of each node of the first layer. ConvNets are typically trained for pattern recognition, such as speech processing, language processing, and visual processing. As such, ConvNets may be particularly useful for implementing optical and pattern recognition programs required from the machine learning program.

A ConvNet includes an input layer, a hidden layer, and an output layer, typical of feedforward networks, but the nodes of a ConvNet input layer are generally organized into a set of categories via feature detectors and based on the receptive fields of the sensor, retina, input layer, etc. Each filter may then output data from its respective nodes to corresponding nodes of a subsequent layer of the network. A ConvNet may be configured to apply the convolution mathematical operation to the respective nodes of each filter and communicate the same to the corresponding node of the next subsequent layer. As an example, the input to the convolution layer may be a multidimensional array of data. The convolution layer, or hidden layer, may be a multidimensional array of parameters determined while training the model.

An example a ConvNet is depicted and referenced as 280 in FIG. 2B. As in the basic feedforward network 260 of FIG. 2A, the illustrated example of FIG. 2B has an input layer 282 and an output layer 286. However where a single hidden layer 264 is represented in FIG. 2A, multiple consecutive hidden layers 284A, 284B, and 284C are represented in FIG. 2B. The edge neurons represented by white-filled arrows highlight that hidden layer nodes can be connected locally, such that not all nodes of succeeding layers are connected by neurons. FIG. 2C, representing a portion of the ConvNet 280 of FIG. 2B, specifically portions of the input layer 282 and the first hidden layer 284A, illustrates that connections can be weighted. In the illustrated example, labels W1 and W2 refer to respective assigned weights for the referenced connections. Two hidden nodes 283 and 285 share the same set of weights W1 and W2 when connecting to two local patches.

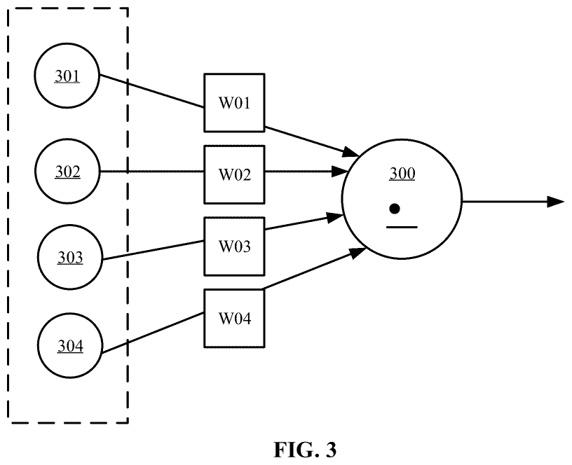

Weight defines the impact a node in any given layer has on computations by a connected node in the next layer. FIG. 3 represents a particular node 300 in a hidden layer. The node 300 is connected to several nodes in the previous layer representing inputs to the node 300. The input nodes 301, 302, 303 and 304 are each assigned a respective weight W01, W02, W03, and W04 in the computation at the node 300, which in this example is a weighted sum.

An additional or alternative type of feedforward neural network suitable for use in the machine learning program and/or module is a Recurrent neural network (“RNN”). An RNN may allow for analysis of sequences of inputs rather than only considering the current input data set. RNNs typically include feedback loops/connections between layers of the topography, thus allowing parameter data to be communicated between different parts of the neural network. RNNs typically have an architecture including cycles, where past values of a parameter influence the current calculation of the parameter. That is, at least a portion of the output data from the RNN may be used as feedback or input in calculating subsequent output data. In some embodiments, the machine learning module may include an RNN configured for language processing (e.g., an RNN configured to perform statistical language modeling to predict the next word in a string based on the previous words). The RNN(s) of the machine learning program may include a feedback system suitable to provide the connection(s) between subsequent and previous layers of the network.

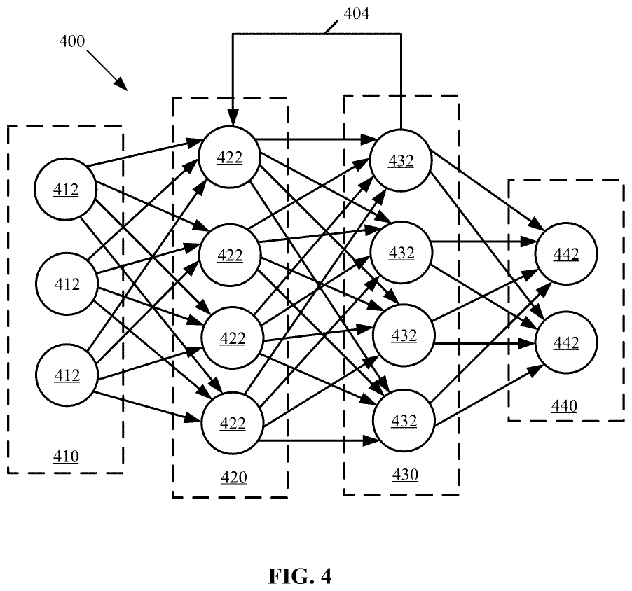

An example RNN is referenced as 400 in FIG. 4. As in the basic feedforward network 260 of FIG. 2A, the illustrated example of FIG. 4 has an input layer 410 (with nodes 412) and an output layer 440 (with nodes 442). However, where a single hidden layer 264 is represented in FIG. 2A, multiple consecutive hidden layers 420 and 430 are represented in FIG. 4 (with nodes 422 and nodes 432, respectively). As shown, the RNN 400 includes a feedback connector 404 configured to communicate parameter data from at least one node 432 from the second hidden layer 430 to at least one node 422 of the first hidden layer 420. It should be appreciated that two or more nodes of a subsequent layer may provide or communicate a parameter or other data to a previous layer of the RNN 400. Moreover, in some embodiments, the RNN 400 may include multiple feedback connectors 404 (e.g., connectors 404 suitable to communicatively couple pairs of nodes and/or connector systems 404 configured to provide communication between three or more nodes). Additionally or alternatively, the feedback connector 404 may communicatively couple two or more nodes having at least one hidden layer between them (i.e., nodes of nonsequential layers of the RNN 400).

In an additional or alternative embodiment, the machine learning program may include one or more support vector machines. A support vector machine may be configured to determine a category to which input data belongs. For example, the machine learning program may be configured to define a margin using a combination of two or more of the input variables and/or data points as support vectors to maximize the determined margin. Such a margin may generally correspond to a distance between the closest vectors that are classified differently. The machine learning program may be configured to utilize a plurality of support vector machines to perform a single classification. For example, the machine learning program may determine the category to which input data belongs using a first support vector determined from first and second data points/variables, and the machine learning program may independently categorize the input data using a second support vector determined from third and fourth data points/variables. The support vector machine(s) may be trained similarly to the training of neural networks (e.g., by providing a known input vector, including values for the input variables) and a known output classification. The support vector machine is trained by selecting the support vectors and/or a portion of the input vectors that maximize the determined margin.

As depicted, and in some embodiments, the machine learning program may include a neural network topography having more than one hidden layer. In such embodiments, one or more of the hidden layers may have a different number of nodes and/or the connections defined between layers. In some embodiments, each hidden layer may be configured to perform a different function. As an example, a first layer of the neural network may be configured to reduce a dimensionality of the input data, and a second layer of the neural network may be configured to perform statistical programs on the data communicated from the first layer. In various embodiments, each node of the previous layer of the network may be connected to an associated node of the subsequent layer (dense layers).

Generally, the neural network(s) of the machine learning program may include a relatively large number of layers (e.g., three or more layers) and are referred to as deep neural networks. For example, the node of each hidden layer of a neural network may be associated with an activation function utilized by the machine learning program to generate an output received by a corresponding node in the subsequent layer. The last hidden layer of the neural network communicates a data set (e.g., the result of data processed within the respective layer) to the output layer. Deep neural networks may require more computational time and power to train, but the additional hidden layers provide multistep pattern recognition capability and/or reduced output error relative to simple or shallow machine learning architectures (e.g., including only one or two hidden layers).

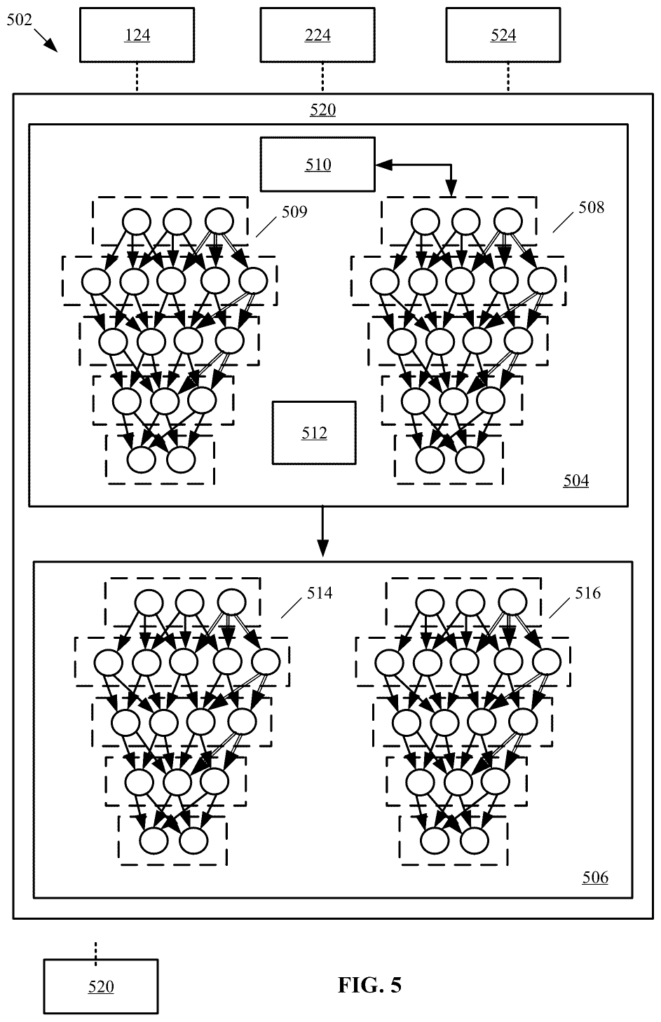

Referring now to FIG. 5 and some embodiments, an artificial intelligence program 502 may include a front-end algorithm 504 and a back-end algorithm 506. The artificial intelligence program 502 may be implemented on an AI processor 520. The instructions associated with the front-end algorithm 504 and the back-end algorithm 506 may be stored in an associated memory device and/or storage device of the system (e.g., memory device 124 and/or storage device 224) communicatively coupled to the AI processor 520, as shown. Additionally or alternatively, the system may include one or more memory devices and/or storage devices (represented by memory 524 in FIG. 5) for processing use and/or including one or more instructions necessary for operation of the AI program 502. In some embodiments, the AI program 502 may include a deep neural network (e.g., a front-end algorithm 504 configured to perform pre-processing, such as feature recognition, and a back-end algorithm 506 configured to perform an operation on the data set communicated directly or indirectly to the back-end algorithm 506). For instance, the front-end algorithm 504 can include at least one ConvNet 508 communicatively coupled to send output data to the back-end algorithm 506.

Additionally or alternatively, the front-end algorithm 504 can include one or more AI algorithms 510, 512 (e.g., statistical models or machine learning programs such as decision tree learning, associate rule learning, recurrent artificial neural networks, support vector machines, and the like). In various embodiments, the front-end algorithm 504 may be configured to include built in training and inference logic or suitable software to train the neural network prior to use (e.g., machine learning logic including, but not limited to, image recognition, mapping and localization, autonomous navigation, speech synthesis, document imaging, or language translation). For example, a ConvNet 508 and/or AI algorithm 510 may be used for image recognition, input classification, and/or support vector training.

In some embodiments and within the front-end algorithm 504, an output from an AI algorithm 510 may be communicated to a ConvNet 508 or 509, which processes the data before communicating an output from the ConvNet 508, 509 and/or the front-end algorithm 504 to the back-end algorithm 506. In various embodiments, the back-end algorithm 506 may be configured to implement input and/or model classification, speech recognition, translation, and the like. For instance, the back-end algorithm 506 may include one or more ConvNets 514 or dense networks 516.

For instance and in some embodiments of the AI program 502, the program may be configured to perform unsupervised learning, in which the machine learning program performs the training process using unlabeled data (e.g., without known output data with which to compare). During such unsupervised learning, the neural network may be configured to generate groupings of the input data and/or determine how individual input data points are related to the complete input data set (e.g., via the front-end algorithm 504). For example, unsupervised training may be used to configure a neural network to generate a self-organizing map, reduce the dimensionally of the input data set, and/or to perform outlier/anomaly determinations to identify data points in the data set that falls outside the normal pattern of the data. In some embodiments, the AI program 502 may be trained using a semi-supervised learning process in which some but not all of the output data is known (e.g., a mix of labeled and unlabeled data having the same distribution).

In some embodiments, the AI program 502 may be accelerated via an AI processor 520 (e.g., hardware). The machine learning framework may include an index of basic operations, subroutines, and the like (primitives) typically implemented by AI and/or machine learning algorithms. Thus, the AI program 502 may be configured to utilize the primitives of the AI processor 520 to perform some or all of the calculations required by the AI program 502. Primitives suitable for inclusion in the AI processor 520 include operations associated with training a ConvNet (e.g., pools), tensor convolutions, activation functions, basic algebraic subroutines and programs (e.g., matrix operations, vector operations), numerical method subroutines and programs, and the like.

It should be appreciated that the machine learning program may include variations, adaptations, and alternatives suitable to perform the operations necessary for the system, and the present disclosure is equally applicable to such suitably configured machine learning and/or artificial intelligence programs, modules, etc. For instance, the machine learning program may include one or more long short-term memory (“LSTM”) RNNs, convolutional deep belief networks, deep belief networks DBNs, and the like. DBNs, for instance, may be utilized to pre-train the weighted characteristics and/or parameters using an unsupervised learning process. Further, the machine learning module may include one or more other machine learning tools (e.g., Logistic Regression (“LR”), Naive-Bayes, Random Forest (“RF”), matrix factorization, and support vector machines) in addition to, or as an alternative to, one or more neural networks, as described herein.

Those of skill in the art will also appreciate that other types of neural networks may be used to implement the systems and methods disclosed herein, including, without limitation, radial basis networks, deep feed forward networks, gated recurrent unit networks, auto encoder networks, variational auto encoder networks, Markov chain networks, Hopefield Networks, Boltzman machine networks, deep belief networks, deep convolutional networks, deconvolutional networks, deep convolutional inverse graphics networks, generative adversarial networks, liquid state machines, extreme learning machines, echo state networks, deep residual networks, Kohonen networks, and neural turning machine networks, as well as other types of neural networks known to those of skill in the art.

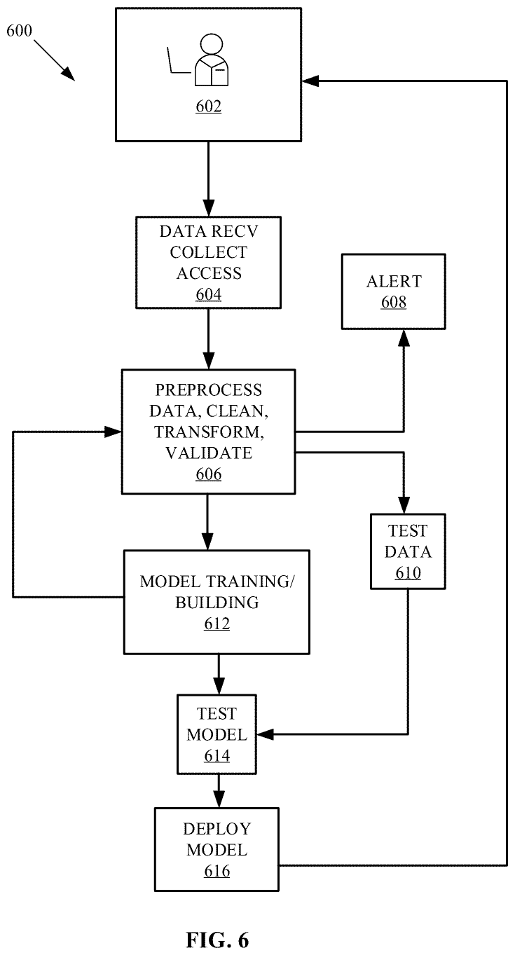

FIG. 6 is a flow chart representing a method 600, according to at least one embodiment, of model development and deployment by machine learning. The method 600 represents at least one example of a machine learning workflow in which steps are implemented in a machine learning project.

In step 602, a user authorizes, solicits, manages, or initiates the machine-learning workflow. This may represent a user such as human agent, or customer, soliciting machine-learning assistance or AI functionality to simulate intelligent behavior (such as a virtual agent) or other machine-assisted or computerized tasks that may, for example, entail visual perception, speech recognition, decision-making, translation, forecasting, predictive modelling, and/or suggestions as non-limiting examples. In a first iteration from the user perspective, step 602 can represent a starting point. However, with regard to continuing or improving an ongoing machine learning workflow, step 602 can represent an opportunity for further user input or oversight via a feedback loop.

In step 604, user evaluation data is received, collected, accessed, or otherwise acquired and entered as can be termed data ingestion. In step 606 the data ingested in step 604 is pre-processed, for example, by cleaning, and/or transformation such as into a format that the following components can digest. The incoming data may be versioned to connect a data snapshot with the particularly resulting trained model. As newly trained models are tied to a set of versioned data, preprocessing steps are tied to the developed model. If new data is subsequently collected and entered, a new model will be generated. If the preprocessing step 606 is updated with newly ingested data, an updated model will be generated.

Step 606 can include data validation, which focuses on confirming that the statistics of the ingested data are as expected, such as that data values are within expected numerical ranges, that data sets are within any expected or required categories, and that data comply with any needed distributions such as within those categories. Step 606 can proceed to step 608 to automatically alert the initiating user, other human or virtual agents, and/or other systems, if any anomalies are detected in the data, thereby pausing or terminating the process flow until corrective action is taken.

In step 610, training test data such as a target variable value is inserted into an iterative training and testing loop. In step 612, model training, a core step of the machine learning work flow, is implemented. A model architecture is trained in the iterative training and testing loop. For example, features in the training test data are used to train the model based on weights and iterative calculations in which the target variable may be incorrectly predicted in an early iteration as determined by comparison in step 614, where the model is tested. Subsequent iterations of the model training, in step 612, may be conducted with updated weights in the calculations.

When compliance and/or success in the model testing in step 614 is achieved, process flow proceeds to step 616, where model deployment is triggered. The model may be utilized in AI functions and programming, for example to simulate intelligent behavior, to perform machine-assisted or computerized tasks, of which visual perception, speech recognition, decision-making, translation, forecasting, predictive modelling, and/or automated suggestion generation serve as non-limiting examples.

### Generating User Notifications

As part of an engagement between an enterprise and an end user, the enterprise may be required to present certain notifications to end users depending on the end user activity and end user attributes, such as the data stored to the End User Database. The notifications can be automatically generated and transmitted to an end user computing device for display. The notifications include notification content data determined using machine learning technology.

Machine learning technology relies on trained neural networks that accept end user data and end user activity data as inputs and that output recommended notifications based on patterns in the user account data and user activity data. End users engage with the enterprise system to accomplish particular activities, including, without limitation (i) establishing a new product (e.g., a new checking account, savings account, or loan), (ii) transfer resources between products or to an external source (e.g., transfer money to pay a bill), (iii) exchange resources in exchange for third party property (e.g., place a trade of a financial instrument), (iv) seek agent advice and support concerning modification of one or more existing products with an enterprise, or (v) seek technical assistance or service with a variety topics, such as logging into an account, or using features of a mobile software application.

A discussed above the enterprise system authenticates users, captures navigation data, captures system configuration data, and retrieves end user data when a user interacts with the enterprise system. The navigation data and end user data can be analyzed to ascertain the end user activity data that characterizes the recent activities of the end user. End user activities include inputs to an enterprise webpage or mobile software application that reveal an end user was performing or attempting to accomplish certain tasks. In some cases, the system may collect inputs to an Interactive Voice Response (“IVR”) system. The end user data, navigation data, and IVR inputs can be used to determine an engagement driver identification—i.e., the reason an end user is contacting an enterprise.

The enterprise system inputs the navigation data, end user data, and/or IVR inputs to a neural network that determines the most probable engagement driver identification. The system can be trained using historical data. To illustrate with a simplified example, a human can review historical data and apply a label that corresponds to the engagement driver identification. If the human applied label matches the outputs from the machine learning analysis, then the error rate is zero. If the human applied label does not match, then weighted coefficients within the neural network that implements the machine learning technology can be adjusted until the human applied label does match.

In this manner, the accuracy of the neural network is improved. For instance, if the navigation data shows that end users who view webpages associated with a mutual fund product identification prior to contacting the enterprise are almost always engaging the enterprise to place a trade, then the navigation data showing such webpage views will weigh more heavily in the neural network and the coefficients adjusted accordingly. As another example, if the end user data shows the end user has a product identifier associated with a low interest rate saving account, and interest rates have just increased, the historical data might show that such end users are likely engaging the enterprise about opening an new savings account or adjusting the interest rate of an existing account. Thus, such factors will weigh more heavily toward those engagement driver identifications within the neural network.

In other embodiments, the enterprise system may activate a digital recorder to capture and record a verbal interaction between an agent and an end user. The verbal interaction is transcribed into alphanumeric text data that is analyzed using machine learning and natural language processing technology to determine an engagement driver identification. Natural language processing technology models the alphanumeric text data using word vectors and analyzes the frequency of occurrence of certain machine encoded communication elements (i.e., words or phrases). Machine learning technology is used to analyze the word vectors along with the frequency data to identify probabilities that the underlying engagement touched upon particular topics. This information can in turn be used to determine the reason why an end user initiated an engagement with an enterprise.

A notification generation software module analyzes the engagement driver identification to make recommendations concerning notification content data to transmit to user computing devices. That is, the notification varies depending on why the end user has contacted the provider. If, for instance, the end user is contacting a provider to acquire a new product (i.e., a new checking account), then the notification content data might include text disclosing value data such as the account interest rate or content data disclosing terms of the account, such as a minimum threshold value of resource that must be kept in the account (i.e., a minimum balance). The notification content could also vary depending on the end user data and system configuration data, such incorporating particular security warnings if a transaction is being conducted from a computing device that is not identified as being typically associated with a given end user.

The notification generation software module can be implemented as a rules-based software process or as software that performs statistical analyses using machine learning techniques to automatically analyze end user evaluation data. The machine learning technology can be used, for instance, to evaluate end users and make certain determinations, such as an end user being a high-value end user to which certain notifications do not need to be sent.

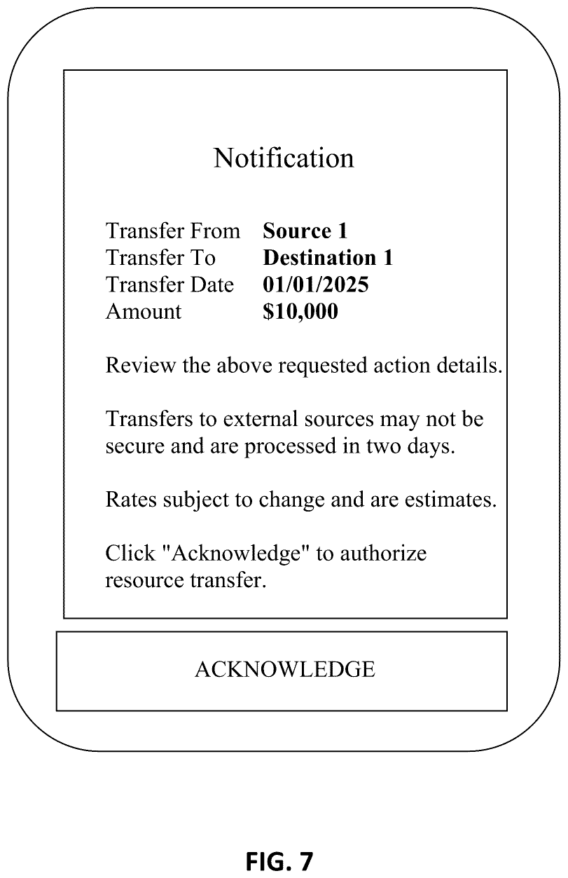

An example user interface for displaying a notification is depicted in FIG. 7. Once notification content data is generated by the enterprise system, the system can transmit the notification content data to an end user computing device for display. The notification content data can be displayed through an Internet browser software application, a GUI on a mobile software application, a short message service text message transmitted to the user computing device, a push notifications transmitted to the user computing device, an email, or through other suitable digital communication techniques. In some embodiment, the notification content data can be read aloud using a text-to-speech software application that is able to convert text data to spoken audio data.

The notification content data can be transmitted to the user computing device along with interface assembly instructions software code that is used to generate a GUI by the user computing device. The interface instructions can be, for instance, hypertext markup language (“html”) or JAVA script software code. The notification content data includes alphanumeric text with a specified font and color that describes the notification. The notification display data can also incorporate images, graphics, and layout data that instruct the user computing device to render various graphical elements in a specified arrangement.

Functions or links for responding to a notification data can also be included with the notification display data, such as the “Acknowledge” button shown in FIG. 7. Selecting the function to accept the terms of the notification data sends a response to the server computing device and the server computing device inputs the response into the user account in a database. The agent can then review the user's response. Based on the user response, an enterprise agent be prompted to move to a next interaction. This process may be repeated until the engagement is terminated.

Although the foregoing description provides embodiments of the invention by way of example, it is envisioned that other embodiments may perform similar functions and/or achieve similar results. Any and all such equivalent embodiments and examples are within the scope of the present invention.

What is claimed is:

1. A system for building a customized conditional interface comprising a first computing device that comprises a first processor and a first memory device storing data and executable code that, when executed, causes the first processor to:
(a) capture system configuration data and network activity data from a remote user computing device;
(b) determine an engagement driver identification using the system configuration data and the network activity data as well as end user data loaded from an end user database;
(c) generate notification content data based on the engagement driver identification and the end user data; and
(d) package the notification content data with interface assembly instruction software code that, when executed by a user computing device, outputs the notification content data to a display device integrated with the end user computing device.

2. The system for building a customized conditional input interface of claim 1, wherein:
(a) the first computing device comprises at least one neural network; and
(b) the at least one neural network is used to determine the engagement driver identification.

3. The system for building a customized conditional input interface of claim 2, wherein the at least one neural network is configured with a support vector machine network architecture.

4. The system for building a customized conditional input interface of claim 2, wherein the at least one neural network comprises a ConvNet architecture.

5. The system for building a customized conditional input interface of claim 2, wherein running the executable code stored to a second memory device causes a second processor to:
(a) capture notification content data transmitted to the user computing device;
(b) create a notification database record comprising the network activity data, the system configuration data, end user account data, and the notification content data;
(c) generate known labeling data using the notification database record;
(d) generate an error rate by comparing the notification content data to the known labeling data; and
(e) training the at least one neural network by adjusting one or more neural network parameters to reduce the error rate.

6. The system for building a customized conditional input interface of claim 1, wherein executing the interface assembly instruction software code by the user computing device causes the device to display the notification content data on a graphical user interface that is output to the display device.

7. The system for building a customized conditional input interface of claim 1, wherein:
(a) the first computing device comprises at least one neural network; and
(b) the at least one neural network is used to generate the notification content data.

8. The system for building a customized conditional input interface of claim 7, wherein the at least one neural network is configured with a support vector machine network architecture.

9. The system for building a customized conditional input interface of claim 9, wherein the at least one neural network comprises a ConvNet architecture.

10. The system for building a customized conditional input interface of claim 1, wherein:
(a) the user computing device processes the notification content data and the interface assembly instructions to generate the graphical user interface;
(b) the graphical user interface comprises an accept function; and wherein
(c) when the accept function is selected by an end user, the first computing device transmits an alert to an agent computing device permitting an engagement between the end user and an agent to proceed.

11. A system for building a customized conditional input interface comprising a first computing device that comprises a first processor and a first memory device storing data and executable code that, when executed, causes the first processor to:
(a) capture from a user computing device, (i) a user interface transmit command for user interface data utilized by the user computing device to generate a graphical user interface, (ii) system configuration data, (iii) network activity data, and (iv) user security data;
(b) process the system configuration data by comparing the received system configuration data and user security data against stored system configuration data and stored user security data, wherein (i) if the captured data does not match the stored data, an alert is transmitted to the user computing device, and (ii) if the captured data does match the stored data, the processor loads end user data;
(c) determine an engagement driver identification using the system configuration data, the network activity data, and the end user data;
(d) generate notification content data based on the engagement driver identification and the end user data; and
(e) package the notification content data with interface assembly instruction software code that, when executed by a user computing device, outputs the notification content data to a display device integrated with the end user computing device.

12. The system for building a customized conditional input interface of claim 11, wherein:
(a) the processor captures end user inputs to an interactive voice response system; and
(b) the end user inputs are also used to determine the engagement driver identification.

13. The system for building a customized conditional input interface of claim 11, wherein executing the interface assembly instruction software code by the user computing device causes the device to display the notification content data on a graphical user interface that is output to the display device.

14. A system for building a customized conditional input interface comprising a first computing device that comprises a first processor and a first memory device storing data and executable code that, when executed, causes the first processor to:
(a) activate a digital recorder that stores audio data from an engagement between an agent and an end user;
(b) convert the audio data to machine encoded communication elements;
(c) generate an engagement driver identification using the machine encoded communication elements;
(d) capture system configuration data and network activity data from a remote user computing device;
(e) generate notification content data based on the engagement driver identification and end user data loaded from the first memory device; and
(f) package the notification content data with interface assembly instruction software code that, when executed by a user computing device, outputs the notification content data and an accept input function to a display device integrated with the end user computing device.

15. The system for building a customized conditional input interface of claim 14, wherein the first computing device comprises a first neural network that is used to generate the engagement driver identification.

16. The system for building a customized conditional input interface of claim 15, wherein the neural network is implemented with a ConvNet architecture.

17. The system for building a customized conditional input interface of claim 15, wherein the neural network is implemented with a recurrent neural network having at least three intermediate layers.

18. The system for building a customized conditional input interface of claim 14, wherein executing the interface assembly instruction software code by the user computing device causes the device to display the notification content data on a graphical user interface that is output to the display device.

19. The system for building a customized conditional input interface of claim 14, wherein:
(a) the first computing device comprises at least one neural network; and
(b) the at least one neural network is used to generate the notification content data.

20. The system for building a customized conditional input interface of claim 14, wherein:
(a) the user computing device processes the notification content data and the interface assembly instructions to generate a graphical user interface;
(b) the graphical user interface comprises a accept function; and wherein
(c) when the accept function is selected by an end user, the first computing device transmits an alert to an agent computing device permitting an engagement between the end user and an agent to proceed.
